(19) United States
(12) Patent Application Publication
(10) Pub. No.: US 2003/0079079 A1
(43) Pub. Date: Apr. 24, 2003

(54) Method to control the operating speed of computer storage device

(76) Inventor: Chia-Yuan Pang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/105,648

(22) Filed: Mar. 25, 2002

(30) Foreign Application Priority Data
Oct. 19, 2001 (TW) 90125963

(51) Int. Cl. G06F 12/00

(52) U.S. Cl. 711/112

(57) ABSTRACT

A method to control the operating speed of computer storage device by determining the transmitting mode of a computer interface. A first speed transmitting mode is used to output a controlling signal to the exterior interface when the transforming interface receives a reset signal provided by the exterior interface. If the transforming interface receives a reply signal provided by the exterior interface, the first speed transmitting mode is switched to a second speed transmitting mode having a slower transmitting speed than the first speed transmitting mode. An ATAPI command is sent to the interface controller by the transforming interface through an interior BUS to dictate allowed transmitting speed to limit the writing speed of the computer storage media.

### BACKGROUND OF THE INVENTION

1. Field of the Invention

The present invention relates in general to a method to control the operating speed of computer storage media by determining the transmitting mode of a computer interface. In particular, the present invention relates to controlling the operating speed of computer storage media according to the information of the transmitting efficiency of the transforming interface of a computer when the data is written to the computer storage media to prevent data buffer under-run.

2. Description of the Related Art

The conventional CD-R/RW drive writes data to a compact disc (CD) at a constant speed. Therefore, a 1×speed CD drive writes data to a CD at 150 k byte/sec, and a 16×speed CD drive writes data to a CD at 2400 k byte/sec. However, data buffer under-run occurs when the transmitting efficiency of a computer interface is slower than the writing speed of a CD drive.

Presently, there are some standards for the transforming interface for writing data to a CD drive, such as E-IDE/ATA/ATAPI, SCSI, Serial ATA, USB 1.1, USB 2.0, PC-Card, Card Bus, and IEEE 1394. When the CD-R/RW drive is connected to a computer through a transforming interface, the type of the transforming interface is obtained by hardware drivers, drive's firmware, and hardware, so a constant maximum speed limitation of data writing to a CD-R/RW drive is obtained.

### SUMMARY OF THE INVENTION

The object of the present invention is to provide a method to control the operating speed of computer storage media by determining the transmitting mode of a computer interface, which detects the transmitting efficiency of the transforming interface of a computer before the data is written to the computer storage media.

To achieve the above-mentioned object, the present invention provides a method to control the operating speed of computer storage device by determining the transmitting mode of a computer interface. A first speed transmitting mode is used to output a controlling signal to the exterior interface when the transforming interface receives a reset signal provided by the exterior interface. If the transforming interface receives a reply signal provided by the exterior interface, the first speed transmitting mode is switched to a second speed transmitting mode having a slower transmitting speed than the first speed transmitting mode. A ATAPI command is send to the interface controller by the transforming interface through an interior BUS to notify a allowed transmitting speed to limit the writing speed of the computer storage device.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is an architecture block diagram of a CD-R/RW drive system according to the embodiment of the present invention.

FIG. 2 is a flow chart of the operation process according to the embodiment of the present invention.

### DETAILED DESCRIPTION OF THE PREFERRED EMBODIMENT

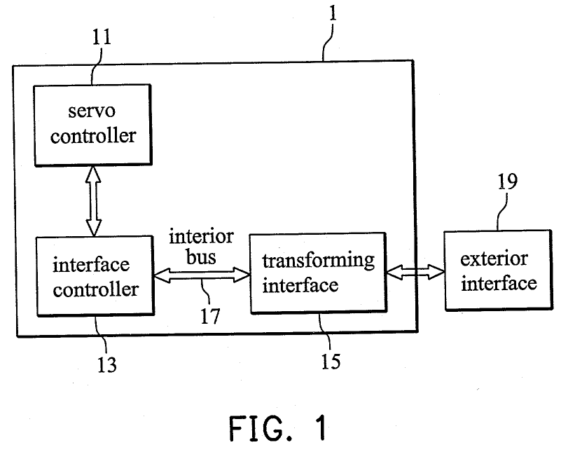

FIG. 1 is an architecture block diagram of a CD-R/RW drive system according to the embodiment of the present invention.

The CD-R/RW drive 1 comprises a servo controller 11, an interface controller 13 and a transforming interface 15, wherein, the transforming interface 15 is coupled to the interface controller 13 through an interior bus 17, IDE BUS for example. In addition, the transforming interface 15 processes USB 2.0 to IDE transformation, which is operated in full speed mode (12 M bit/sec) or high speed mode (480 M bit/sec). Moreover, the transforming interface 15 is coupled to an exterior interface 19, the transforming interface 15 transmits data in full speed mode when the exterior interface 19 is a Hub or a Host Control Card with USB 1.1 connector, and the transforming interface 15 transmits data in high speed mode when the exterior interface 19 is a Hub or a Host Control Card with USB 2.0 connector.

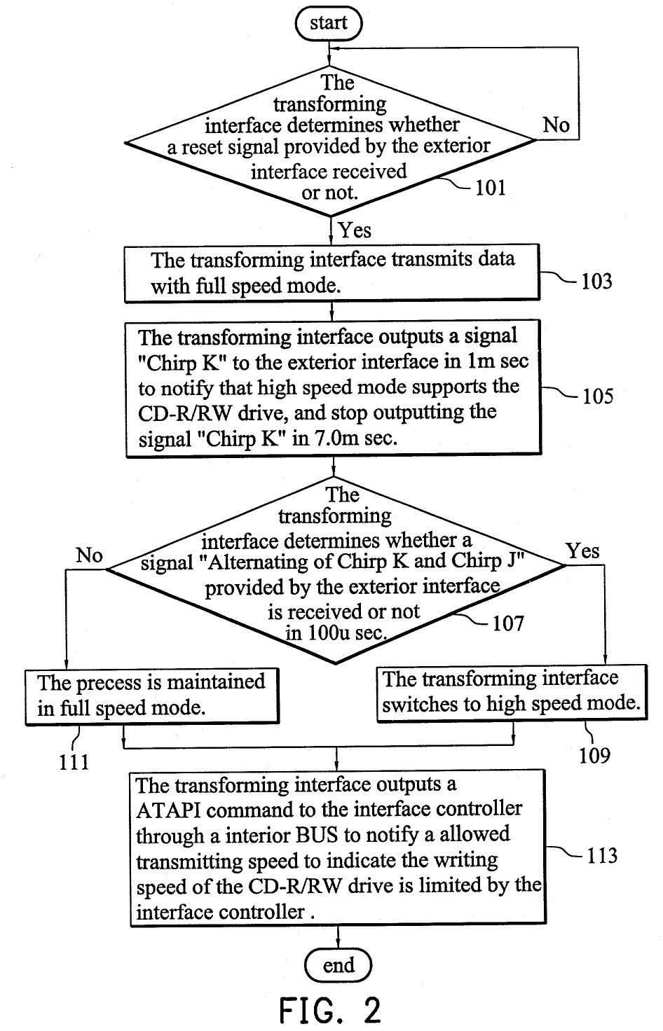

FIG. 2 is a flow chart of the operation process according to the embodiment of the present invention. The data-transmitting mode of the transforming interface 15 is determined according to the flow chart shown in FIG. 2.

Step 101: the transforming interface 15 determines whether a reset signal provided by the exterior interface 19 is received or not. If yes, the process goes to step 103, if not, the process maintains the present operation mode, and goes back to step 101.

Step 103: the transforming interface 15 transmits data with full speed mode. At this time, the interior data-transmitting mode is full speed mode no matter the exterior interface 19 performs in high speed mode or not.

Step 105: the transforming interface 15 outputs a signal “Chirp K” to the exterior interface 19 in 1 m sec to notify that high speed mode supports the CD-R/RW drive 1, and stop outputting the signal “Chirp K” in 7.0 m sec.

Step 107: the transforming interface 15 determines whether a signal “Alternating of Chirp K and Chirp J” provided by the exterior interface 19 is received or not in 100 u sec. If yes, the process goes to step 109, if not, the process goes to step 111.

Step 109: the transforming interface 15 switches to high speed mode, then the precess goes to step 113.

Step 111: the precess is kept in full speed mode.

Step 113: since the data-transmitting mode is determined, the transforming interface 15 outputs a predetermined ATAPI command to the interface controller 13 through an interior BUS 17 to notify a allowed transmitting speed to indicate the writing speed of the CD-R/RW drive 1 is limited by the interface controller 13.

Therefore, when the interface controller 13 receives the ATAPI command, if the data transmitting rate is 2400 k byte/sec, the maximum data writing speed is limited to 4×speed (four times speed) to prevent data buffer under-run, and if the data transmitting rate is 4800 k byte/sec, the maximum data writing speed is not limited.

In addition, at step 113, if the data-transmitting mode is full speed mode, the interior BUS 17 outputs the vendor defined ATAPI command /0xFA, 0x00, 0x03, 0x84, 0x00, 0x00, 0x00, 0x00, 0x00, 0x00, 0x00, 0x00/ to the interface controller 13, wherein /0x03, 0x84/ represents the data transmitting rate is 900 k byte/sec. If the data-transmitting mode is high speed mode, the interior BUS 17 outputs the vendor defined ATAPI command /0xFA, 0x00, 0x12, 0xC0, 0x00, 0x00, 0x00, 0x00, 0x00, 0x00, 0x00, 0x00/ to the interface controller 13, wherein /0x12, 0xC0/ represents the data transmitting rate is 4800 k byte/sec.

Similarly, when the transforming interface for writing data to the CD-R/RW drive 1 is Card Bus to IDE, the interior BUS 17 outputs the ATAPI command /0xFA, 0x00, 0x07, 0xAD, 0x00, 0x00, 0x00, 0x00, 0x00, 0x00, 0x00, 0x00/ to the interface controller 13, wherein /0x07, 0xAD/ represents the data transmitting rate is 1965 k byte/sec, then the interface controller 13 limits the maximum data writing speed to 12×.

In addition, assuming that the data writing speeds of a CD-R/RW drive are 1×speed (150 k byte/sec), 4×speed (600 k byte/sec), 8×speed (1200 k byte/sec), 12×speed (1800 k byte/sec), and 16×speed (2400 k byte/sec), the transforming interfaces are USB 1.1 to IDE, USB 2.0 to IDE, IEEE 1394 to IDE, and Card Bus to IDE, the transforming interface is obtained by the hardware and firmware of the CD-R/RW drive, and the maximum data transmitting rate of USB 1.1 is under 900 k byte/sec, the maximum data transmitting rate of USB 2.0 is under 4800 k byte/sec, the maximum data transmitting rate of IEEE 1394 is under 11600 k byte/sec, and the maximum data transmitting rate of Card Bus is under 1965 k byte/sec, therefore, when the CD-R/RW drive is connected to the computer by the transforming interface USB 1.1 to IDE, the firmware of the CD-R/RW drive limits the maximum data writing speed to 4×speed, automatically. Therefore, the transmitting efficiency of a computer interface is higher than the maximum data writing speed of the CD-R/RW drive, so data buffer under-run is prevented.

In addition, when the CD-R/RW drive is connected to the computer by the transforming interface USB 2.0 to IDE or IEEE 1394 to IDE, the firmware of the CD-R/RW drive doesn't limit the maximum data writing speed of the CD-R/RW drive because the transmitting efficiency of the two transforming interfaces is always higher than the maximum data writing speed of a CD-R/RW drive.

Moreover, when the CD-R/RW drive is connected to the computer by the transforming interface Card Bus to IDE, the firmware of the CD-R/RW drive limits the maximum data writing speed to 12×speed, automatically. Therefore, the transmitting efficiency of a computer interface is higher than the maximum data writing speed of the CD-R/RW drive, so data buffer under-run is prevented.

Accordingly, the present invention limits the maximum data writing speed of the CD-R/RW drive according to the transmitting efficiency of a computer interface to prevent data buffer under-run.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for determining the transmitting mode of a computer interface to control the operating speed of computer storage device, having a servo controller, an interface controller and a transforming interface coupling to an exterior interface, the method comprising the following steps:
using a first speed transmitting mode to output a controlling signal to the exterior interface when the transforming interface receives a reset signal provided by the exterior interface;
switching the first speed transmitting mode to a second speed transmitting mode having a slower transmitting speed than the first speed transmitting mode when the transforming interface receives a reply signal provided by the exterior interface; and
sending a ATAPI command to the interface controller by the transforming interface through an interior BUS to notify a allowed transmitting speed to limit the writing speed of the computer storage media.

2. The method for determining the transmitting mode of a computer interface to control the operating speed of computer storage device as claimed in claim 1, wherein the transforming interface is USB 1.1 to IDE, USB 2.0 to IDE, IEEE 1394 to IDE or card bus to IDE.

3. The method for determining the transmitting mode of a computer interface to control the operating speed of computer storage device as claimed in claim 1, wherein the exterior interface is a hub or a host control card.

4. The method for determining the transmitting mode of a computer interface to control the operating speed of computer storage device as claimed in claim 1, wherein the BUS is a IDE BUS.
